(19) United States
(12) Patent Application Publication
(10) Pub. No.: US 2005/0094501 A1
(43) Pub. Date: May 5, 2005

(54) Data extraction method for a multi-session optical

(76) Inventors: Chua-Hsiang Tsai, Dayuan Township (TW); Steve Lee, Taipei (TW)

Correspondence Address: RABIN & Berdo, PC, 1101 14TH STREET, NW, SUITE 500, WASHINGTON, DC, 20005, US

(21) Appl. No.: 10/968,135

(22) Filed: Oct. 20, 2004

(30) Foreign Application Priority Data
Oct. 31, 2003 (TW) 92130422

(51) Int. Cl. G11B 7/085

(52) U.S. Cl. 369/30.18; 369/47.22; 369/124.01

(57) ABSTRACT

A data extraction method for extracting data from an optical disc with multiple sessions. First, the method reads TOC (Table of Contents) areas of sessions of an optical disc to recognize the sessions with non-repeated addresses of the optical disc. Finally, the method extracts data from the non-repeated sessions of the optical disc.

### BACKGROUND OF THE INVENTION

1. Field of the Invention

The present invention relates to an optical disc data extraction technology and in particular to a data extraction method for extracting data from a multi-session optical disc.

2. Description of the Related Art

A multi-session optical disc is an optical disc comprises multiple sessions. A session is an area for recording data or information. Each session includes a Lead-in area, a data area, and a Lead-out area. The Lead-in area of a session records the name, the number, the lengths of tracks, and the locations of tracks. The Lead-in area also includes a TOC (Table of Contents) area for recording start addresses of tracks. Therefore, a pointer recorded in a TOC area of the present session indicates the start address of the next session. Usually, the pointer is recorded in address B0h of TOC area.

At present, audio discs are generally mono-session discs. FIG. 5 is a diagram of a mono-session audio optical disc. The fourth column records pointers (Point). The numbers 1 to 17 represent audio tracks 1 to 17. A mono-session optical disc can be read by a regular optical disc drive.

FIG. 6 is a representative analysis diagram of a regular multi-session optical disc. The first column represents session numbers (Sess.). There are five sessions in this disc. The session numbers 1 to 5 represent session 1 to session 5 of the multi-session optical disc. The fourth column records pointers (Point). Each session includes a certain pointer allocated in address B0h for indicating the start address of the next session. For example, the contents of address B0h of the first session are “05h 06h 01h,” indicating the start address of the second session is “05h 06h 01h,” analogous to other sessions.

At present, audio CD players can only play mono-session optical discs, but not multi-session optical discs. One solution for audio CD players to read multi-session optical disc is to read only the first session of a multi-session optical disc individually, while ignoring other sessions, this method however, affects playback quality. Thus, conventional multi-session optical discs can only be read by an optical disc drive typically installed in a computer or other device.

Otherwise, some optical discs are specifically formatted, as shown in FIG. 7. The specifically formatted optical discs may include errors or intentionally repeated information, such as start addresses, causing difficulty in data extraction. FIG. 7 is a representative analysis diagram of a multi-session optical disc with specific formatting. (FIG. 7 includes FIG. 7a and FIG. 7b) The pointers indicating the start addresses stored in TOC areas of the sessions are repeated. For example, the contents of the pointer of address B0h in the TOC area of the second session (sess. 02) are “39h 05h 32h,” indicating the start address of the third session. The contents of the pointer of address B0h in the TOC area of the third session (sess. 03), indicating the start address of the fourth session (sess. 04), are also “39h 05h 32h.” The repeated contents appeared in the sessions of an optical disc may make an optical disc drive unable to finish the analysis or reading of TOC, and thus result in halt or even crash. This leads to inconvenience of user and causing damage to optical disc drivers.

At present, optical disc drives adopt a TOC area first-read method to read audio optical discs. This method means that optical disc drives read or analyse the TOC prior to the reading of data area. Thus, if TOC areas include errors or repeated information seriously, the optical disc drives will halt or crash due to the incomplete TOC data read operation, thus impeding other data extraction operations.

Conventional data extraction technology has no effective solution to extract data from multi-session optical discs with specific formatting.

Accordingly, an object of the invention is to provide a data extraction method for extracting data from a multi-session optical disc with specific formatting. The inventive method is also operative for a mono-session optical disc or a regular formatted multi-session optical disc. Moreover, the inventive method can be implemented in an optical disc drive to enhance usability thereof.

To achieve the foregoing and other objects, the invention discloses a data extraction method for extracting data from an optical disc with multiple sessions. Each session has a pointer for indicating the start address of the next session.

The method first reads the pointers of the sessions. The method then determines if the start addresses of the sessions are repeated according to the read pointers. Finally, the method extracts data from the sessions with non-repeated start addresses.

### BRIEF DESCRIPTION OF THE DRAWINGS

The present invention can be more fully understood by reading the following detailed description and examples with references made to the accompanying drawings, wherein:

FIG. 1 is a flowchart of the data extraction method for extracting data from an optical disc with a plurality of sessions.

FIG. 2 is a diagram of a machine-readable storage medium for storing a computer program providing a data extraction method for extracting data from an optical disc with a plurality of sessions.

FIG. 3A is a block diagram of an optical disc drive for extracting data from an optical disc with a plurality of sessions.

FIG. 3B is a diagram of the data extraction device for extracting data from an optical disc with a plurality of sessions.

FIG. 4 is a diagram of the detailed functions of the optical disc drive for extracting data from an optical disc with a plurality of sessions.

FIG. 5 is a diagram of a mono-session audio optical disc.

FIG. 6 is a representative analysis diagram of a regular multi-session optical disc.

FIG. 7 is a representative analysis diagram of a multi-session optical disc with specific formatting. (FIG. 7 includes FIG. 7a and FIG. 7b)

### DETAILED DESCRIPTION OF THE INVENTION

As summarized above, the present invention discloses a data extraction method for extracting data from an optical disc with multiple sessions. Each session has a pointer for indicating a start address of a next session.

First, the pointers of the sessions are read. It is determined if the start addresses of the sessions are repeated according to the read pointers. Finally, the data stored in the sessions with non-repeated start addresses is extracted. Afterwards, the extracted data can be stored in a buffer of an optical disc drive for other operations. That is, the data stored in the sessions with repeated start addresses is ignored while the data stored in the sessions with non-repeated start addresses is extracted. Thus, the device, such as a personal computer, having the optical disc drive can execute other data extraction operations.

The determination of repeated start addresses is accomplished by certain steps. A first pointer of a first session of the sessions in the optical disc is read to obtain a second session start address of a second session. A second pointer of the second session according to the second session start address is then read to obtain a third session start address of a third session. Next, a third pointer of the third session according to the third session start address is read to obtain a fourth session start address of a fourth session. The third session start address and the fourth session start address are compared to determine if they are repeated. If the start addresses are repeated, the optical disc is recognized as a multi-session optical disc with specific formatting. Here, the first, the second, and the third pointers are recorded in address B0h of TOC areas of the first, the second, and the third session.

If the optical disc is recognized as a multi-session optical disc with specific formatting, a decoding verification function of the optical disc drive, such as c2point, may be disabled. If an optical disc drive is installed in a personal computer or other devices, the function of c2point is to respond with error messages to the personal computer or the devices when errors occur in data decoding. Nevertheless, if the extracted optical disc is a multi-session optical disc with specific formatting, the data stored in the optical disc is different from the data stored in regular optical discs. The c2point verification function may verify that decoding of the optical disc has failed and respond with error messages to the computer or the devices. Thus, the decoding verification function of c2point must be disabled for other play operations.

As mentioned above, the invention can resolve the play problem of an optical disc drive for extracting data from a multi-session optical disc with specific formatting. The present invention utilizes pointers of the sessions in an optical disc to determine if the extracted optical disc is a multi-session optical disc with specific formatting. If the extracted optical disc is a multi-session optical disc with specific formatting, the data recorded in the sessions with repeated start addresses will be ignored and the data recorded in the sessions with non-repeated start addresses will be read and stored in a buffer. The data stored in the buffer can be provided for play function execution. Thus, whether the extracted optical disc is regular or specific formatting, the optical disc drive can function normally.

In addition, the invention discloses a storage medium for storing a computer program for providing a data extraction method for extracting data from an optical disc with multiple sessions. The method comprises the above mentioned steps.

Moreover, the invention provides an optical disc drive for extracting data from an optical disc with multiple sessions. Each session has a pointer for indicating a start address of the next session. The optical disc drive comprises a buffer, an optical pick up head, and a microprocessor.

The optical pick up head reads the pointers of the sessions. The microprocessor determines if the start addresses of the sessions are repeated according to the pointers, extracts data from the sessions with non-repeated start addresses, and stores the extracted data into the buffer. If the extracted optical disc is recognized as a multi-session optical disc with specific formatting, the microprocessor further disables a decoding verification function of the optical disc drive, such as the c2point function.

The microprocessor further comprises a first pointer reader, a second pointer reader, a third pointer reader, a start address determination device, and a specific format recognition device.

The first pointer reader reads a first pointer of a first session of the sessions in the optical disc to obtain a second session start address of a second session. The second pointer reader, coupled to the first pointer reader, reads a second pointer of the second session according to the second session start address to obtain a third session start address of a third session. The third pointer reader, coupled to the second pointer reader, reads a third pointer of the third session according to the third session start address to obtain a fourth session start address of a fourth session. The start address determination device, coupled to the third pointer reader, determines if the third session start address and the fourth session start address are repeated. The specific format recognition device, coupled to the start address determination device, recognizes the optical disc as a multi-session optical disc with specific formatting if the third session start address and the fourth session start address are repeated.

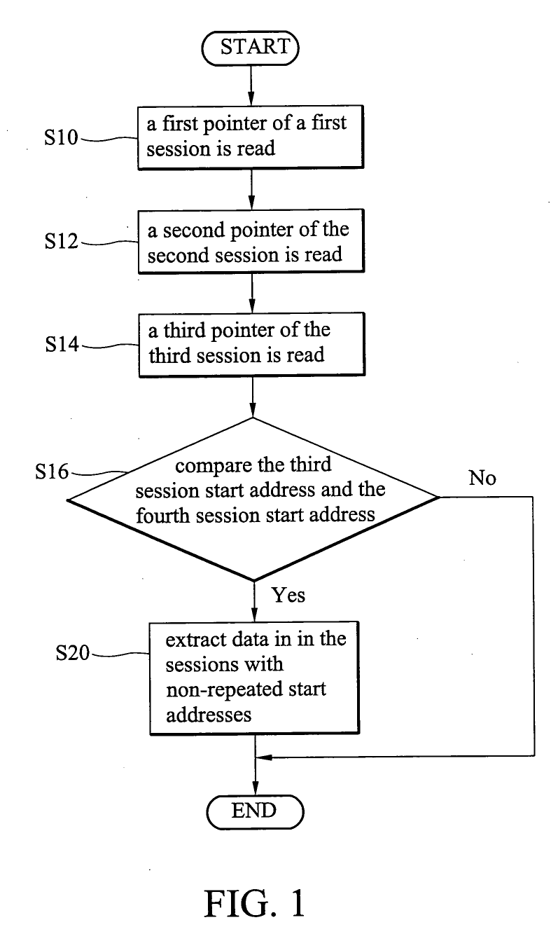

FIG. 1 is a flowchart of the data extraction method for extracting data from an optical disc with a plurality of sessions. First, a first pointer of a first session of the sessions in the optical disc is read to obtain a second session start address of a second session (step S10). Next, a second pointer of the second session according to the second session start address is then read to obtain a third session start address of a third session (step S12). Carrying on, a third pointer of the third session according to the third session start address is read to obtain a fourth session start address of a fourth session (step S14).

The third session start address and the fourth session start address are compared to determine if they are repeated (step S16). If the start addresses are repeated, the optical disc is recognized as a multi-session optical disc with specific formatting. Finally, the data stored in the sessions with non-repeated start addresses is extracted (step S20). Afterwards, the extracted data may be stored into a buffer of the optical disc drive for other operations.

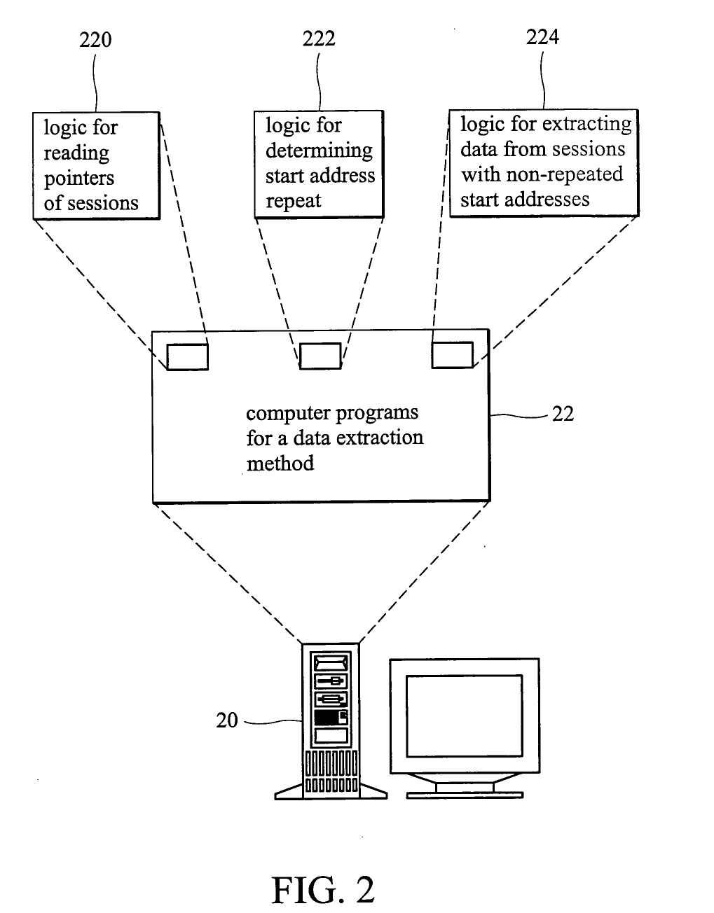

FIG. 2 is a diagram of a machine-readable storage medium storing a computer program providing a data extraction method for extracting data from an optical disc with a plurality of sessions. A machine-readable storage medium 20 stores a computer program 22. The computer program 22 provides a data extraction method for extracting data from an optical disc with a plurality of sessions. The computer program 22 mainly includes logic for reading pointers of sessions 220, logic for determining start address repeat 222, and logic for extracting data from sessions with non-repeated start addresses 224.

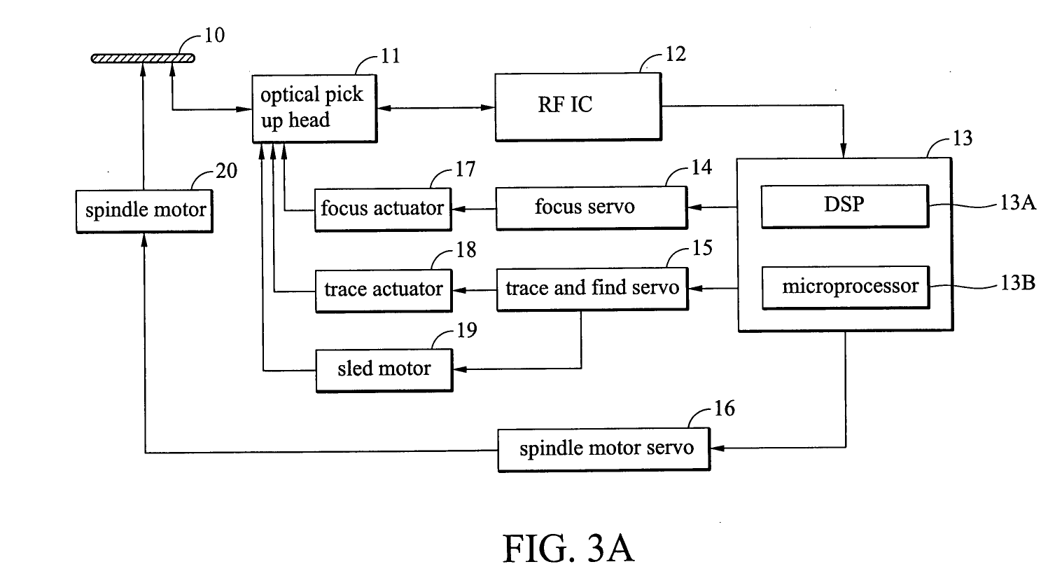

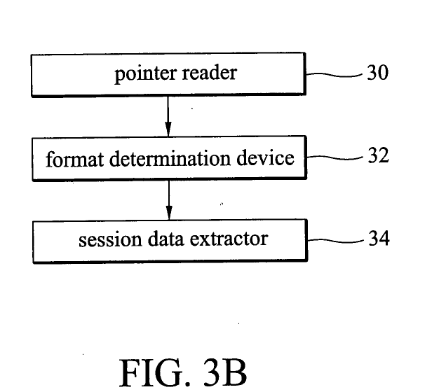

FIG. 3A is a block diagram of an optical disc drive for extracting data from an optical disc with a plurality of sessions. The optical pick up head 11 acquires reflection signals. The reflection signals are processed and amplified by the RF IC 12. FE signals, TE signals, and other data are sent to DSP 13A and microprocessor 13B. Microprocessor 13B stores the extracted data into a buffer.

In addition, microprocessor 13B outputs servo drive signals to Focus servo 14, Trace and Find servo 15, and spindle motor servo 16 according to the FE signals and the TE signals to control the controllable drive components (Focus actuator 17, Trace actuator 18, Sled motor 19, and spindle motor 20) for ensuring correction of data extraction and data read-write operations.

FIG. 3B is a diagram of the data extraction device for extracting data from an optical disc with a plurality of sessions. In one embodiment, an optical disc data extraction device for extracting data from a multi-session optical disc in an optical disc drive is disclosed. The optical disc data extraction device comprises a pointer reader 30, a format determination device 32, and a session data extractor 34.

The pointer reader 30 (e.g. an optical pick up head 11, in FIG. 3A) reads pointers of sessions of an optical disc. The format determination device 32 (e.g. a microprocessor 13B, in FIG. 3A) determines if start addresses of the sessions are repeated according to the pointers. The session data extractor 34 extracts data from the sessions with non-repeated start addresses and stores the extracted data into a buffer. If the extracted optical disc is determined as a multi-session optical disc with specific formatting, that is, the extracted optical disc has sessions with repeated start address, the format determination device 32 disables a decoding verification function, i.e. c2point function. The disablement of the c2point function is advantageous for disc playing as depicted above.

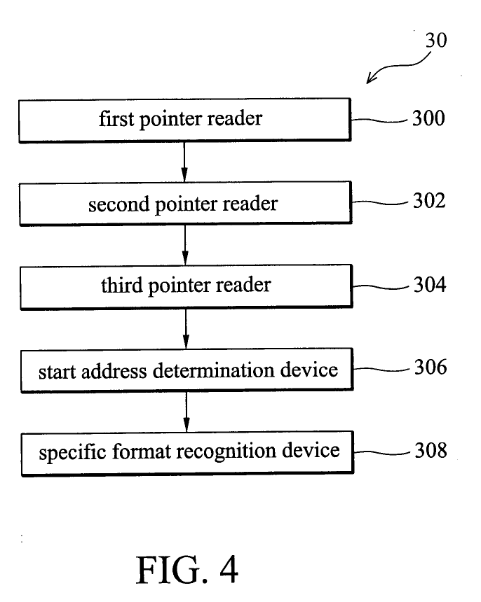

FIG. 4 is a diagram of detailed functions of the optical disc drive for extracting data from an optical disc with a plurality of sessions. The format determination device further comprises a first pointer reader 300, a second pointer reader 302, a third pointer reader 304, a start address determination device 306, and a specific format recognition device 308.

The first pointer reader 300 reads a first pointer, such as B0h of the TOC area, of a first session of the sessions in an optical disc to obtain a second session start address of a second session. The second pointer reader 302 reads a second pointer of the second session according to the second session start address to obtain a third session start address of a third session. The third pointer reader 304 reads a third pointer of the third session according to the third session start address to obtain a fourth session start address of a fourth session. Similarly, the second and the third pointers are recorded in address B0h of the TOC areas of the second and the third sessions.

The start address determination device 306 determines if the third session start address and the fourth session start address are repeated. Under certain conditions, the start address determination device 306 can delete the sessions with repeated start addresses. The specific format recognition device 308 recognizes the optical disc as a multi-session optical disc with specific formatting if the third session start address and the fourth session start address are repeated.

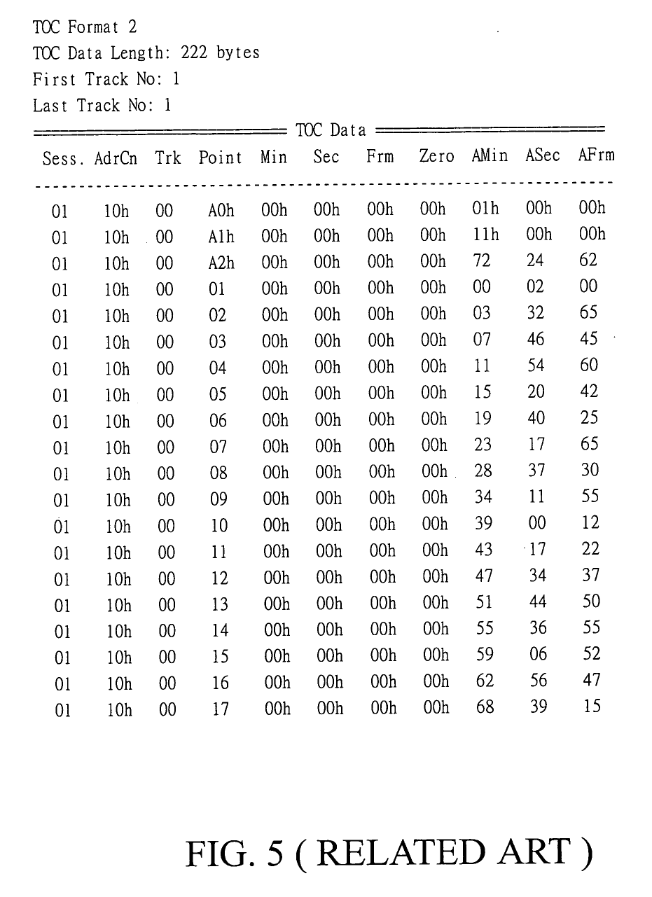

FIG. 5 is a diagram of a mono-session audio optical disc, which can be read by regular optical disc drives. The fourth column marks points from 1 to 17 for audio track 1 to audio track 17. The present invention is suitable for mono-session audio optical discs equally. If the extracted optical disc is a mono-session optical disc, the inventive method extracts data from the TOC area and stores the extracted data in a buffer. The stored data can be provided for other data extraction operations.

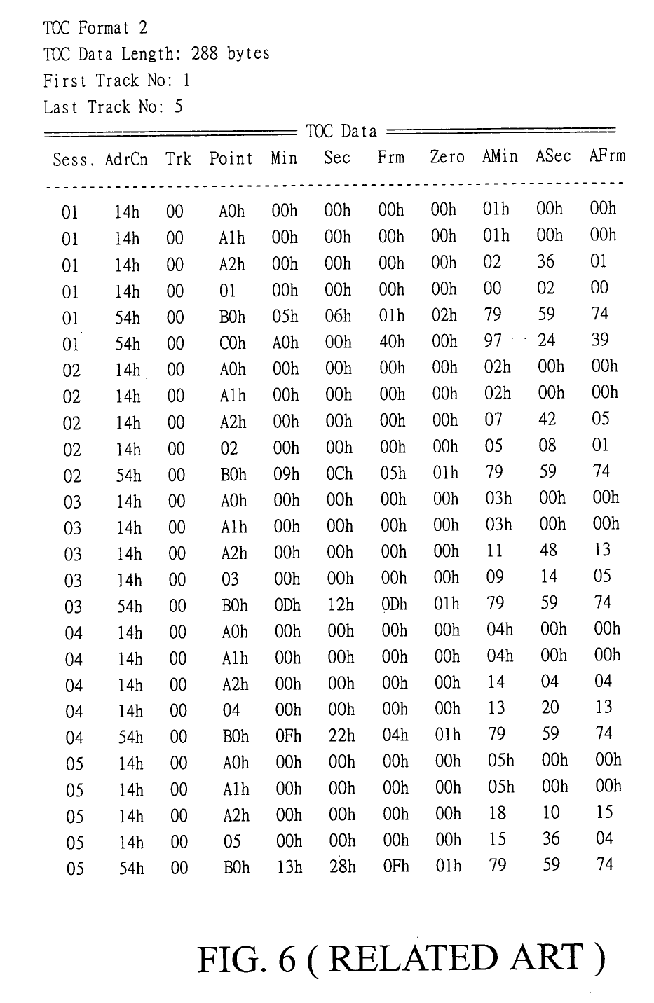

FIG. 6 is a representative analysis diagram of a regular multi-session optical disc. In one embodiment, the first column (Sess.) indicates an optical disc with five sessions. The address B0h records a pointer indicating the start address of the next session. For example, the address B0h of the first session indicates the start address of the second session is “05h 06h 01h.” The address B0h of the second session indicates the start address of the third session, i.e. “09h 0Ch 05h.”

The inventive method first reads the first pointer from the first session to obtain the second session start address. The method then reads the second pointer from the second session according to the second session start address to obtain the third session start address. Carrying on, the method reads the third pointer from the third session to obtain the fourth session start address according to the third session start address.

Finally, the method compares the third session start address and the fourth session start address. In the embodiment, the third session start address and the fourth session start address are different. Similarly, the method reads the start address of the following sessions until all the sessions are read. Thus, the method can determine the extracted optical disc is not a specifically formatted multi-session optical disc. The method can store data, extracted from TOC areas, in buffers for other data extraction operations.

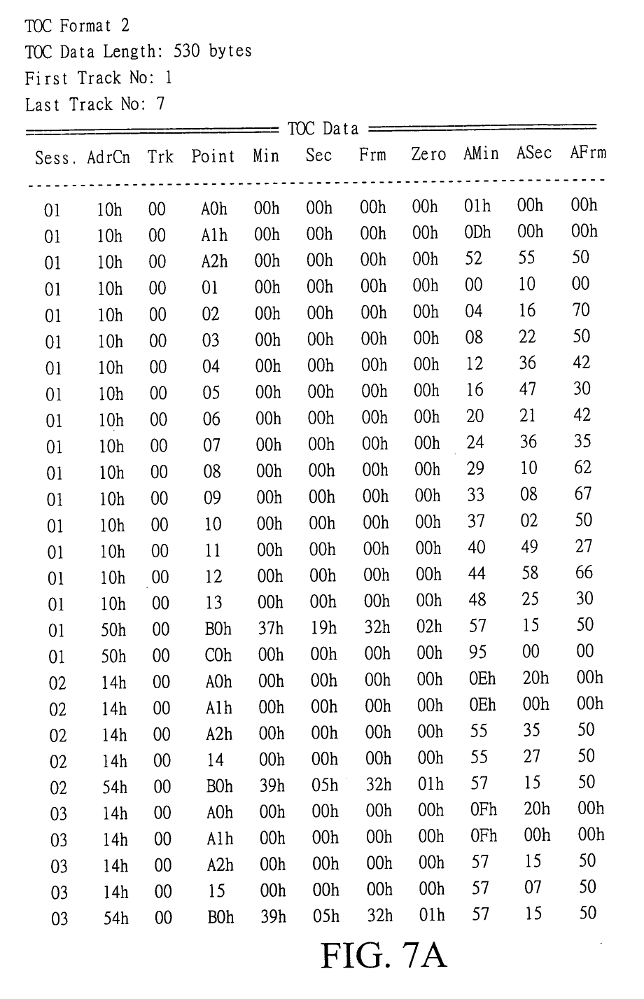

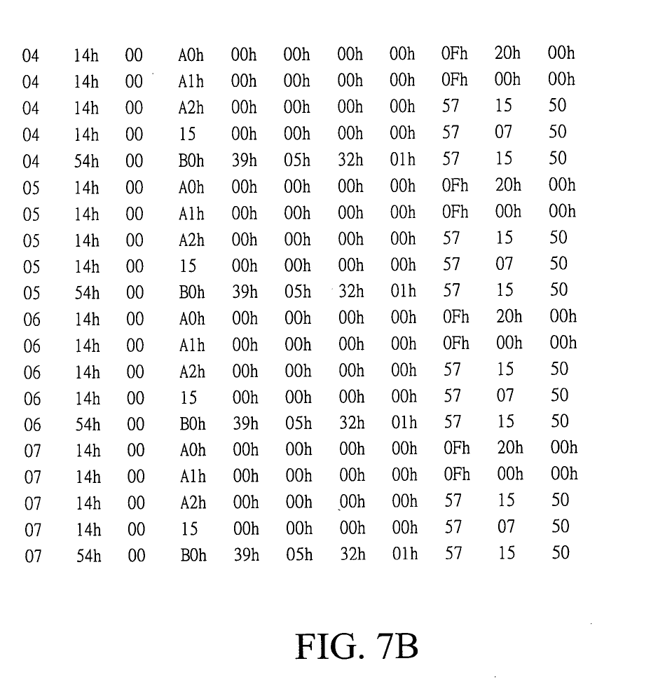

FIG. 7 is a representative analysis diagram of a multi-session optical disc with specific formatting. (FIG. 7 includes FIG. 7a and FIG. 7b) In one embodiment, the inventive method is applied to an optical disc drive. The optical disc drive first reads the first pointer from the first session (Sess.=01), e.g. address B0h of TOC area, to obtain the start address of the second session “37h 19h 32h.”

The optical disc drive reads the second pointer from the second session according to the second session start address to obtain the start address of the third session, “39h 05h 32h.” The optical disc drive then reads the fourth pointer to obtain the fourth session start address according to the third session start address, i.e. “39h 05h 32h.” The optical disc drive compares the third and the fourth session start addresses and determines if they are repeated. In the embodiment, the third and the fourth session start addresses are repeated. The optical disc is recognized as a specifically formatted multi-session optical disc. The optical disc drive may delete the sessions with repeated start addresses.

The optical disc drive repeats the mentioned operations until all the sessions are read. In the embodiment, the optical disc drive may read, determine, and delete seven sessions. Afterwards, the optical disc drive stores data extracted from the TOC area of the first session in a buffer for other operations.

Thus, a data extraction method for extracting data from an optical disc with multiple sessions is provided. The inventive method can be implemented in an optical disc drive to resolve the conventional data extraction problems.

It will be appreciated from the foregoing description that the device and method described herein provide a dynamic and robust solution to the data extraction problem of multi-session optical discs. If, for example, the format of the multi-session optical disc is altered, the device and method of the present invention can adjusted accordingly.

The methods and system of the present invention, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code transmitted over a transmission medium, such as electrical wire, cable, fiberoptics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A data extraction method for extracting data from an optical disc with a plurality of sessions, wherein each of the sessions has a pointer for indicating a start address of a next session, comprising the steps of:
reading the pointers of the sessions;
determining if the start addresses of the sessions are repeated according to the pointers; and
extracting data from the sessions with non-repeated start addresses.

2. The method as claimed in claim 1, wherein the determination further comprises the steps of:
reading a first pointer of a first session of the sessions in the optical disc to obtain a second session start address of a second session;
reading a second pointer of the second session according to the second session start address to obtain a third session start address of a third session;
reading a third pointer of the third session according to the third session start address to obtain a fourth session start address of a fourth session; and
determining if the third session start address and the fourth session start address are repeated.

3. The method as claimed in claim 2, wherein the first pointer is recorded in address B0h of a TOC area of the first session.

4. The method as claimed in claim 2, wherein the second pointer is recorded in address B0h of a TOC area of the second session.

5. The method as claimed in claim 2, wherein the third pointer is recorded in address B0h of a TOC area of the third session.

6. The method as claimed in claim 1, further comprising disabling a decoding verification function for the optical disc if the start addresses of the sessions are repeated.

7. The method as claimed in claim 6, wherein the decoding verification function is a c2point decoding verification function.

8. An optical disc drive for extracting data from an optical disc with a plurality of sessions, wherein each of the sessions has a pointer for indicating a start address of a next session, the optical disc drive comprising:
a buffer;
an optical pick up head, reading the pointers of the sessions; and
a microprocessor, determining if the start addresses of the sessions are repeated according to the extracted pointers, and storing the data of the sessions with non-repeated start addresses into the buffer.

9. The optical disc drive as claimed in claim 8, wherein the microprocessor further comprises:
a first pointer reader, reading a first pointer of a first session of the sessions in the optical disc to obtain a second session start address of a second session;
a second pointer reader, coupled to the first pointer reader, reading a second pointer of the second session according to the second session start address to obtain a third session start address of a third session;
a third pointer reader, coupled to the second pointer reader, reading a third pointer of the third session according to the third session start address to obtain a fourth session start address of a fourth session;
a start address determination device, coupled to the third pointer reader, determining if the third session start address and the fourth session start address are repeated; and
a specific format recognition device, coupled to the start address determination device, recognizing the optical disc drive as a specific multi-session optical disc if the third session start address and the fourth session start address are repeated.

10. The optical disc drive as claimed in claim 9, wherein the first pointer is recorded in address B0h of a TOC area of the first session.

11. The optical disc drive as claimed in claim 9, wherein the second pointer is recorded in address B0h of a TOC area of the second session.

12. The optical disc drive as claimed in claim 9, wherein the third pointer is recorded in address B0h of a TOC area of the third session.

13. The optical disc drive as claimed in claim 8, wherein the micro processor further disables a decoding verification function of the optical disc drive if the start addresses of the sessions are repeated.

14. The optical disc drive as claimed in claim 13, wherein the decoding verification function is a c2point decoding verification function.

15. A machine-readable storage medium for storing a computer program providing data extraction method for extracting data from an optical disc with a plurality of sessions, wherein each of the sessions has a pointer for indicating a start address of a next session, the method comprising the steps of:
reading the pointers of the sessions;
determining if the start addresses of the sessions are repeated according to the extracted pointers; and
extracting data from the sessions with non-repeated start addresses.

16. The storage medium as claimed in claim 15, wherein the determination further comprises the steps of:
reading a first pointer of a first session of the sessions in the optical disc to obtain a second session start address of a second session;
reading a second pointer of the second session according to the second session start address to obtain a third session start address of a third session;
reading a third pointer of the third session according to the third session start address to obtain a fourth session start address of a fourth session; and
determining if the third session start address and the fourth session start address are repeated.

17. The storage medium as claimed in claim 16, wherein the first pointer is recorded in address B0h of a TOC area of the first session.

18. The storage medium as claimed in claim 16, wherein the second pointer is recorded in address B0h of a TOC area of the second session.

19. The storage medium as claimed in claim 16, wherein the third pointer is recorded in address B0h of a TOC area of the third session.

20. The storage medium as claimed in claim 15, further comprising disabling a decoding verification function for the optical disc if the start addresses of the sessions are repeated.

21. The storage medium as claimed in claim 20, wherein the decoding verification function is a c2point decoding verification function.
